(19) United States
(12) Patent Application Publication
(10) Pub. No.: US 2013/0280362 A1
(43) Pub. Date: Oct. 24, 2013

(54) MOLDING ROLLER, APPARATUS AND METHOD FOR MANUFACTURING SAME

(71) Applicant: CHIA-LING HSU, Tu-Cheng (TW)

(72) Inventor: CHIA-LING HSU, Tu-Cheng (TW)

(73) Assignee: HON HAI PRECISION INDUSTRY CO., LTD., Tu-Cheng (TW)

(21) Appl. No.: 13/586,899

(22) Filed: Aug. 16, 2012

(30) Foreign Application Priority Data
Apr. 20, 2012 (TW) 101114246

(51) Int. Cl. B29C 59/02; B65H 81/00; B31F 5/04; B65C 9/04

(52) U.S. Cl. 425/385; 156/446; 156/184; 156/379.6

(57) ABSTRACT

A molding roller includes a base roller and a flexible molding film. The base roller has a rolling surface. The molding film is wound around the rolling surface. The molding film has a molding surface. The molding surface defines impression patterns. The present invention further relates to an apparatus and provides a method for manufacturing the molding roller.

### BACKGROUND

1. Technical Field

The present disclosure relates to a molding roller, an apparatus and a method for manufacturing the molding roller.

2. Description of Related Art

Optical films define a number of micro structures. One method for forming the micro structures is a roll forming process using a metal roller. The metal roller has a rolling surface defining impression patterns coupled with the micro structures. A laser knife is used for directly forming the impression patterns on the metal roller. However, the forming efficiency of the impression patterns is low, which increases the cost of the roller.

Therefore, it is desirable to provide a molding roller, an apparatus and a method for manufacturing the molding roller that can overcome the above-mentioned limitations.

### BRIEF DESCRIPTION OF THE DRAWINGS

Many aspects of the embodiments should be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of a molding roller, according to a first exemplary embodiment.

FIG. 2 is a schematic view of an apparatus for manufacturing a molding roller, according to a second exemplary embodiment.

FIG. 3 and FIG. 4 are flowcharts of a method for manufacturing a molding roller, according to a third exemplary embodiment.

### DETAILED DESCRIPTION

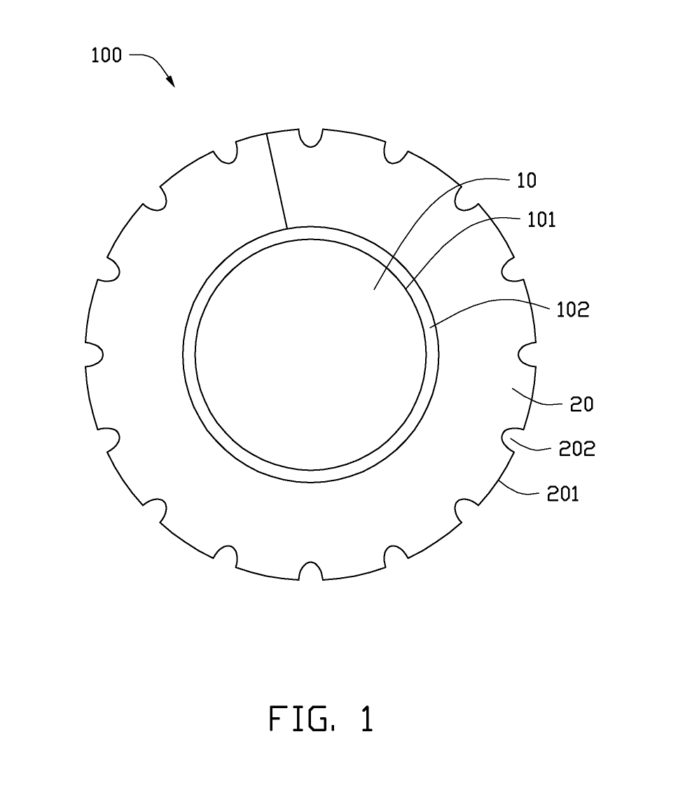

FIG. 1 illustrates a molding roller 100 in accordance to a first embodiment. The molding roller 100 includes a cylindrical base roller 10 and a flexible molding film 20. The base roller 10 has a rolling surface 101. The rolling surface 101 is coated with adhesive glue 102. The molding film 20 is wound around the rolling surface 101 and mounted on the rolling surface 101 via the adhesive glue 102. The base roller 10 may be made of stainless steel or other metals.

The molding film 20 is made of ethylene tetrafluoroethylene (ETFE) or poly tetrafluoroethylene (PTFE). The molding film 20 has a molding surface 201 defining a number of impression patterns 202. In the first embodiment, the impression patterns 202 are micro-grooves. Optical films are easily separated from ETFE or PTFE, therefore the quality of the optical films can be greatly improved.

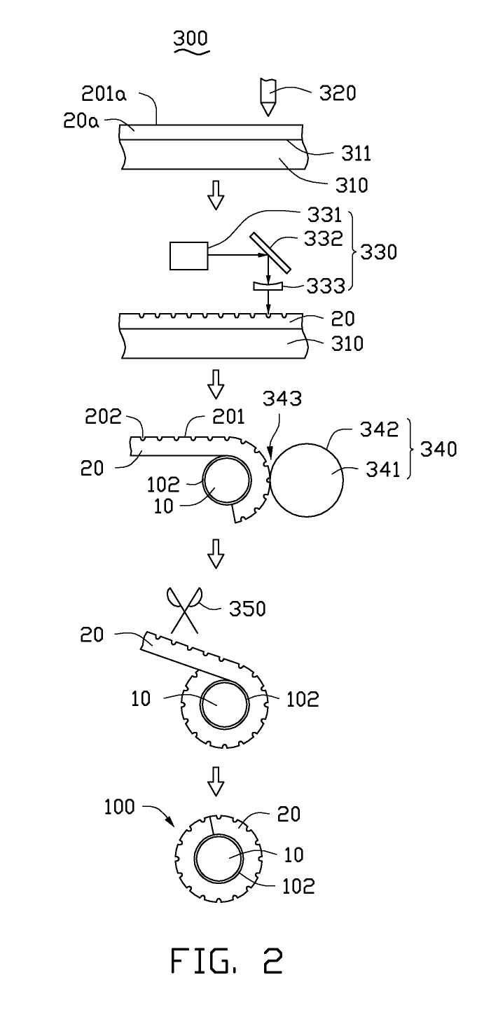

Referring to FIG. 2, an apparatus 300 for manufacturing the molding roller 100, according to a second exemplary embodiment, includes a loading plate 310, a polishing device 320, a processing device 330, a mounting device 340, and a cutting device 350.

The loading plate 310 is used for loading a flexible preprocessed molding film 20a. The loading plate 310 includes a plane loading surface 311. Two opposite ends of the preprocessed molding film 20a are fixed to the loading surface 311. The preprocessed molding film 20a is stripe-shaped and includes a preprocessed molding surface 210a opposite to the loading plate 310. In the second embodiment, the preprocessed molding film 20a is adhered to the loading surface 311.

The polishing device 320 is used for polishing the preprocessed molding surface 201a. In the second embodiment, the polishing device 320 is a diamond knife.

The processing device 330 is used for forming the impression patterns 202 on the preprocessed molding surface 201a to obtain the molding film 20 with the molding surface 201. In the second embodiment, the processing device 330 is a laser knife and includes a laser emitter 331, a reflector 332, and a converging lens 333. The laser emitter 331 is used for emitting laser rays. The transmitting direction of the laser rays is substantially parallel to the pre-manufacturing molding surface 201a. The reflector 332 is used for changing the transmitting direction of the laser rays and reflecting the laser rays to the converging lens 333. The converging lens 333 converges the laser rays to the preprocessed molding surface 201a. In other embodiments, the reflector 332 and the converging lens 333 can be omitted, and the transmitting direction of the laser rays should be substantially perpendicular to the preprocessed molding surface 201a. If the impression patterns 202 are V-shaped grooves, and the processing device 330 is a diamond knife having a V-shaped blade.

The mounting device 340 is used for mounting the molding film 20 on the rolling surface 101 and includes an auxiliary roller 341 having a smooth rolling surface 342. The auxiliary roller 341 is at a predetermined distance from the base roller 10 to form a molding channel 343. The auxiliary roller 341 and the base roller 10 are rotated in opposite directions of each other. The rolling surface 101 is coated with adhesive glue 102. One end of the molding film 20 is adhered on the rolling surface 101, then the base roller 10 and the auxiliary roller 341 are rotated to make the molding film 20 passing through the molding channel 343, and thus the molding film 20 is adhered to the rolling surface 101 via the adhesive glue 102.

The cutting device 350 cuts the molding film 20 to make the length of the molding film 20 substantially equal to the perimeter of the rolling surface 101.

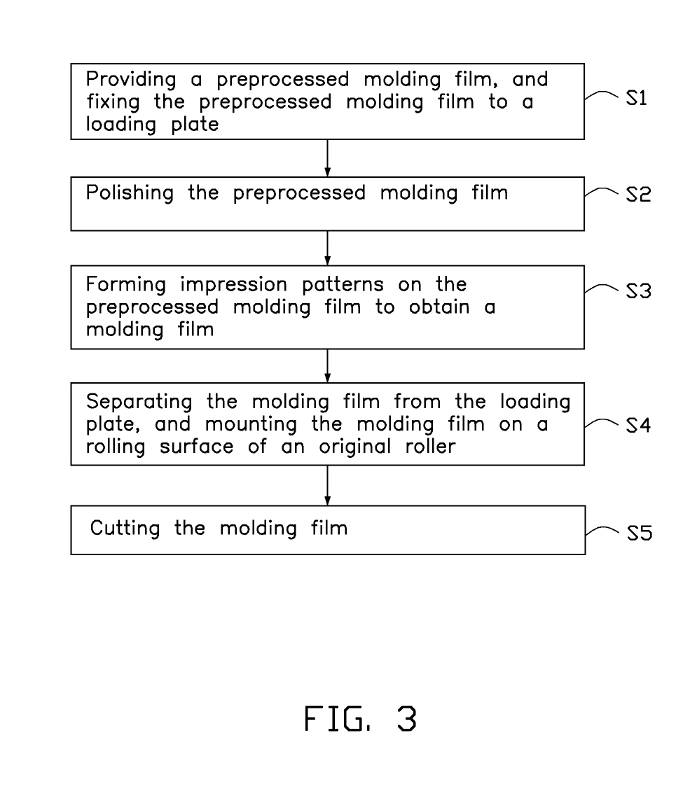

Referring to FIG. 3, a method for manufacturing the molding roller 100 using the apparatus 300, according to a third exemplary embodiment, includes the following steps.

In step S1, a preprocessed molding film 20a is provided and fixed to the loading plate 310. The preprocessed molding film 20a has a preprocessed molding surface 201a opposite to the loading plate 310.

In step S2, the preprocessed molding surface 201a is polished using the polishing device 320.

In step S3, the impression patterns 202 are formed on the preprocessed molding surface 201a using the processing device 330 to obtain the molding film 20 with the molding surface 201.

In step S4, the molding film 20 is separated from the loading plate 310 and is fixed on the rolling surface 101 using the mounting device 340.

In step S5, the molding film 30 is cut to make the length of the molding film 20 substantially equal to a perimeter of the rolling surface 101.

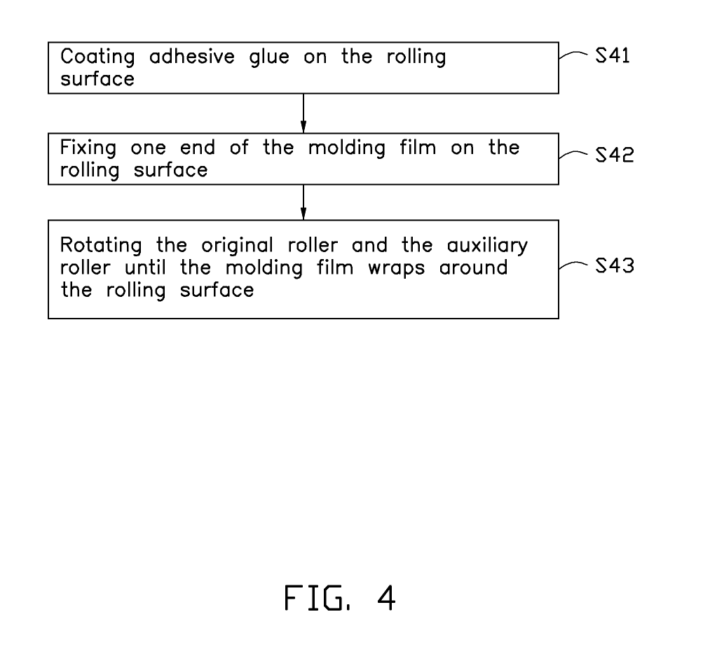

Referring also to FIG. 4, the step S4 further includes the following sub-steps.

In step S41, the rolling surface 101 is coated with the adhesive glue 102.

In step S42, one end of the molding film 20 is adhered on the rolling surface 101, and the molding surface 201 faces the auxiliary roller 341.

In step S43, the base roller 10 and the auxiliary roller 341 are rotated to make the molding film 20 pass through the molding channel 343 until the molding film 20 is wound around the rolling surface 101.

In other embodiments, the order of step S4 and step S5 can be interchanged.

By employing the above described method and the apparatus 100, the impression patterns can be directly formed on the flexible preprocessed molding film 20a to obtain the molding film 20. The molding film 20 is then adhered on the base roller 10. Therefore, the manufacturing efficiency will be greatly improved. Furthermore, when the impression patterns 202 of one molding film 20 is destroyed, the destroyed molding film 20 can be removed from the base roller 10, and another molding film can be mounted to the base roller 10 to form another new molding roller 100. Therefore, the base roller 10 can be used more times, and the molding roller 100 has a relatively low cost.

The above particular embodiments and methods are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

1. A molding roller, comprising:
a base roller having a rolling surface; and
a flexible molding film wound around the rolling surface, the molding film having a molding surface defining a number of impression patterns.

2. The molding roller of claim 1, wherein a length of the molding film is substantially equal to a perimeter of the rolling surface.

3. The molding roller of claim 1, wherein the molding film is made of ethylene tetrafluoroethylene or poly tetrafluoroethylene.

4. The molding roller of claim 1, wherein the base roller is made of metal material.

5. An apparatus for manufacturing a molding roller, comprising:
a loading plate having a plane loading surface configured for loading a flexible preprocessed molding film, wherein the preprocessed molding film has a preprocessed molding surface opposite to the loading plate;
a polishing device configured for polishing the preprocessed molding surface to be smooth;
a processing device configured for forming impression patterns on the preprocessed molding surface to obtain a molding film with a molding surface defining the impression patterns;
a mounting device configured for mounting the molding film to a rolling surface of a base roller; and
a cutting device configured for cutting the molding film.

6. The apparatus of claim 5, wherein the cutting device is configured to cut the molding film at an interval substantially equal to a perimeter of the rolling surface.

7. The apparatus of claim 5, wherein the processing device comprises a laser emitter for emitting laser rays to form the impression patterns on the preprocessed molding surface, and a transmitting direction of the laser rays is substantially perpendicular to the preprocessed molding surface.

8. The apparatus of claim 5, wherein the processing device comprises a laser emitter and a reflector, the laser emitter is configured for emitting laser rays, the reflector is configured for reflecting the laser rays to the preprocessed molding surface.

9. The apparatus of claim 8, wherein a transmitting direction of the laser rays is substantially parallel to the preprocessed molding surface.

10. The apparatus of claim 9, wherein the processing device further comprises a converging lens configured for converging the laser rays to the preprocessed molding surface.

11. The apparatus of claim 5, wherein the processing device comprises a diamond knife.

12. The apparatus of claim 5, wherein the mounting device comprises an auxiliary roller spaced a predetermined distance from the base roller to form a channel between the auxiliary roller and the base roller.

13. A method for manufacturing a molding roller, comprising:
fixing a preprocessed molding film to a loading plate;
polishing the preprocessed molding film to be smooth;
forming impression patterns on the preprocessed molding film to obtain a molding film;
separating the molding film from the loading plate;
mounting the molding film on a rolling surface of a base roller; and
cutting the molding film.

14. The method of claim 13, wherein the molding film is cut at an interval substantially equal to a perimeter of the rolling surface.

15. The method of claim 13, wherein the step of mounting the molding film on a rolling surface of a base roller comprises:
coating adhesive glue on the rolling surface;
fixing one end of the molding film on the rolling surface, with the molding film passing though a channel between the base roller and an auxiliary roller, wherein the molding surface faces the auxiliary roller; and
rotating the base roller and the auxiliary roller in reverse directions until the molding film wraps around the rolling surface.
